(19) United States
(12) Patent Application Publication
(10) Pub. No.: US 2024/0320295 A1
(43) Pub. Date: Sep. 26, 2024

(54) Variable Freezing Method for an Objective Optimisation Problem

(71) Applicant: Mastercard International Incorporated, New York, NY (US)

(72) Inventors: Nicola Mariella, Oranmore (IE); Stephen Patrick Flinter, Dublin (IE)

(21) Appl. No.: 18/577,600

(22) PCT Filed: May 23, 2022
(86) PCT No.: PCT/US2022/030499

§ 371 Date: Jan. 8, 2024

(30) Foreign Application Priority Data
Jul. 9, 2021 (GB) 2109975.9

(51) Int. Cl. G06F 17/16

(52) U.S. Cl. CPC G06F 17/16

(57) ABSTRACT

A computer implemented method for optimising, an objective optimisation problem. The methods begins by receiving the objective optimisation problem. The objective optimisation problem is represented by an L×L objective matrix comprising a plurality of matrix components A set of frozen variables is received. The method determines a set of freezable matrix components corresponding to the set of frozen variables. Then, a contribution vector is determined based on the set of freezable matrix components and the set of frozen variables An equivalent optimisation problem is determined based on the contribution vector and the objective optimisation problem. The equivalent optimisation problem excludes the freezable matrix components such that the equivalent optimisation problem may be solved on a quantum computer using fewer quantum bits than the objective optimisation problem would require.

### CROSS REFERENCE TO RELATED APPLICATION

This application claims the benefit of United Kingdom Patent Application No. 2109975.9, which was filed on Jul. 9, 2021, the entire contents of which are hereby incorporated by reference for all purposes.

### TECHNICAL FIELD

The present disclosure relates to quantum computing. In particular, the present disclosure relates to a computer-implemented method and corresponding computing device for optimising resource usage, for example offer and network allocation.

### BACKGROUND

Quantum computers exploit the quantum superposition characteristics of particles to determine the optimal solution to complex non-linear problems. Unlike classical computers where a classical memory bit will take either a value of “1” or a value of “0”; in a quantum computer, a quantum bit or “qubit” may take a value of “1” “0” or a superposition of “1” and “0”. By resolving the value of a plurality of qubits, the quantum computer can determine the minimum energy state of the qubits and so determine in one computation cycle the optimum solution to a given problem.

In order to exploit the processing efficiency of a quantum computer to solve a complex real world problem, the real world problem and variable may need to be expressed to the quantum computer in a resolvable manner. Determining how to express the problem and variables may be a computationally expensive task which may require more processing cycles than would be needed to solve the problem using a traditional iterative method.

The present disclosure has been devised to mitigate or overcome at least some of the above-mentioned problems.

### SUMMARY OF THE DISCLOSURE

In accordance with a first aspect of the present invention, there is provided a computer implemented method for optimising, by a classical computer, an objective optimisation problem comprising: receiving the objective optimisation problem, the objective optimisation problem being represented by an L×L objective matrix comprising a plurality of matrix components; receiving a set of frozen variables; determining a set of freezable matrix components corresponding to the set of frozen variables; determining a contribution vector based on the set of freezable matrix components and the set of frozen variables; and determining an equivalent optimisation problem based on the contribution vector and the objective optimisation problem, wherein the equivalent optimisation problem excludes the freezable matrix components such that the equivalent optimisation problem can be solved on a quantum computer using fewer quantum bits than the objective optimisation problem would require.

Preferably, the objective matrix is a Quadratic Unconstrained Binary Optimization (QUBO) matrix.

Preferably, the matrix components are objective vectors.

Preferably, the objective vectors belong to a vector set: the set of frozen variables belong to a frozen variable set; and the frozen variable set is a subset of the vector set.

Preferably, the frozen variables are binary variables.

Preferably, each of the frozen variables comprise a variable index.

Preferably, each of the freezable matrix components comprise a vector index corresponding to a respective variable index.

Preferably, the contribution vector is determined by: generating a vector comprising the freezable matrix components; and scaling each freezable matrix component by its corresponding frozen variable.

Preferably, the equivalent optimisation problem is determined by: generating a diagonal matrix based on the contribution vector: determining an intermediate matrix based on the diagonal matrix and the objective matrix; removing a plurality of rows from the intermediate matrix, each of the removed rows corresponding to a respective frozen variable; and removing a plurality of columns from the intermediate matrix, each of the removed columns corresponding to a respective frozen variable.

In accordance with a second aspect of the present invention, there is provided a computer implemented method for optimising an allocation of opportunities to recipients comprising: determining, by a classical computer, a plurality of opportunities to be allocated; determining, by the classical computer, a plurality of recipients to be allocated at least one of the plurality of opportunities; determining, by the classical computer, a respective acceptance likelihood of each of the plurality of recipients accepting each of the plurality of opportunities; determining, by the classical computer, a respective solvable component of each of the plurality of recipients being allocated each of the plurality of opportunities; determining, by the classical computer, a first constraint associated with a cost acceptance of each of the plurality of opportunities by the plurality of recipients; determining, by the classical computer, an objective optimisation problem based on the respective acceptance likelihoods, the respective solvable components, and the first constraint; determining, by the classical computer, an equivalent optimisation problem based on the objective optimisation problem and the respective acceptance likelihoods; solving, by a quantum computer, the equivalent optimisation problem, thereby producing an equivalent solution; and determining, by the classical computer, an optimised allocation of the opportunities to the recipients based on the equivalent solution, the optimised allocation corresponding to the solvable components.

Preferably, the first constraint is determined based on a selection from a plurality of constraints.

Preferably, the method further comprises: determining a second constraint based on a selection from the plurality of constraints; and using the second constraint in the determining of the optimisation problem.

Preferably, the plurality of constraints comprises: a budget constraint; a constraint associated with the uptake of each of the plurality of opportunities by the plurality of recipients; and a constraint that indicates that a plurality of opportunities are mutually exclusive.

Preferably, the determination of the acceptance likelihood comprises populating an m by n acceptance likelihood matrix of values, wherein each respective value provides an indication of the likelihood of a recipient j accepting an opportunity i.

Preferably, the determination of the respective solvable components comprises populating an m by n solvable component matrix of variables, wherein each element of the solvable component matrix corresponds to a respective element of the acceptance likelihood matrix.

Preferably, the objective optimisation problem is determined by: determining an acceptance likelihood vector; determining a solvable component vector; determining a combined vector based on the acceptance likelihood vector and the solvable component vector; and determining the objective optimisation problem based on: the combined vector; the first constraint; and the second constraint.

Preferably, the acceptance likelihood vector is determined by flattening the acceptance likelihood matrix; and the solvable component vector is determined by flattening the solvable component matrix.

Preferably, the equivalent solution is provided as an x by y matrix of binary values.

Preferably, x multiplied by y is less than m multiplied by n.

Preferably, the optimised allocation is provided as an m by n matrix of binary values, each corresponding to a respective solvable component, wherein: a first binary value provides an indication that respective opportunity has been allocated to a recipient; and a second binary value provides an indication that a respective opportunity has not been allocated to a recipient

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the disclosure will now be described, by way of example only, with reference to the accompanying drawings, in which:

FIG. 1 is a computing system;

FIG. 2 is a quantum annealing process carried out by a quantum computer;

FIG. 3 is a method for optimising an objective optimisation problem using a variable freezing method;

FIG. 4 is a real world problem solved by the computing system; and

FIG. 5 is an opportunity allocation system.

### DETAILED DESCRIPTION

### Quadratic Unconstrained Binary Optimisation

A real world problem may be formulated as an objective optimisation problem subject to a number of constraints. The objective optimisation problem may be a combinatorial problem that fits the QUBO (Quadratic Unconstrained Binary Optimisation) form. A QUBO problem is a form of discrete optimisation problems that involves finding a set x of N binary variables {xᵢ} that minimises the objective problem, defined as:

$$E ( x ) = {x}^{T} Q x$$

Where Q is an N×N matrix comprising elements qᵢⱼ that is characteristic of the real world problem, wherein elements qᵢⱼ preferably represent a weight (or a coefficient). Q may be in either a symmetric or upper triangular form. The x term represents a vector having a range of binary values, 0 or 1, i.e. x∈{0, 1}. The diagonal terms of Q represent linear terms whilst the off-diagonal terms of Q represent quadratic terms. Accordingly, the objective problem is defined by the above equation.

A significant application of QUBO emerges from its equivalence to the Ising model, wherein the energy of a configuration of the Ising model is given by a Hamiltonian function defined by a first term and a second term as:

$$H ( σ ) = - {\sum }_{〈 i j 〉} {J}_{ij} {σ}_{i} {σ}_{j} - μ {\sum }_{j} {h}_{j} {σ}_{j}$$

The first term −Σ₍ᵢⱼ₎Jᵢⱼσᵢσⱼ corresponds to an interaction (or coupling strength) Jᵢⱼ between a first site i and a second site j. The first site may have a first spin, a, and the second site may have a second spin, σj, each spin having a value of +1 or −1, i.e. σ∈{−1, 1}ⁿ. The notation [symbol] ij [symbol] indicates that the first site and the second site are nearest neighbours, wherein each pair of sites is counted once. The second term, −μΣⱼhⱼσⱼ represents an interaction between the system and an external bias hⱼ, for example a transverse magnetic field. The external bias is generated by the bias device 144. Therefore, hⱼ is a strength of the magnetic field interacting with the site j having a spin σⱼ. Importantly, interaction Jᵢⱼ and bias hⱼ are programmable parameters that may be adjusted. The Ising model may be translated into a QUBO problem, or vice versa, by defining xᵢ=(σⱼ+1)/2. Accordingly, the QUBO problem advantageously maps to the Ising model which, following the quantum annealing process, leads to a ground state solution corresponding to a minimised solution of the real world problem. Accordingly, the objective problem is implemented by the quantum computing unit 106 as a Hamiltonian with adjustable parameters Jᵢⱼ and hⱼ. Importantly, a length of vector x corresponds to the number N of qubits required to represent the objective optimisation problem.

The coupling interaction is implemented by the coupling devices 142 which preferably couple (or entangles) a first qubit with a second qubit. The coupling devices 142 may be, for example, a superconducting loop. The coupling between the first qubit and the second qubit is either ferromagnetic or anti-ferromagnetic as the qubits interact via their respective magnetic fluxes. A change in flux of the first qubit will affect the flux of the second qubit. If the coupling is ferromagnetic (i.e. Jᵢⱼ>0), it is energetically favourable for a change in flux of the first qubit to produce a similar change in the flux of the second qubit. Accordingly, a clockwise superconducting current in the first qubit will cause a clockwise superconducting current in the second qubit to be more energetically favourable than a counter-clockwise superconducting current. In this case, the first qubit and the second qubit will tend towards the 0 state. If the coupling is anti-ferromagnetic (i.e. Jᵢⱼ<0), it is energetically favourable for a change in the flux of the first qubit to cause an opposite effect in the flux of the second qubit. Accordingly, a clockwise superconducting current in the first qubit will cause a counter-clockwise superconducting current in the second qubit to be more energetically favourable than a clockwise superconducting current. In this case, the first qubit will tend towards the 0 state and the second qubit will tend towards the 1 state.

Accordingly, the QUBO framework may express a real world problem as an energy function which can be provided to the quantum computer. The variables identified in relation to the real world problem are mapped to the variables of the QUBO energy function. The QUBO energy function may be thought of as a matrix wherein each value in the matrix expresses the relationship between two different qubits in the quantum computer. For simplicity some embodiments herein may be described in terms of a problem expressed in a two-dimensional QUBO matrix. However, other embodiments may express problems in terms of three or more dimensions. Once the energy function has been input to the quantum computer, the physical properties of the quantum computer will cause the function to resolve to a minimum value landscape which may be output as an optimisation of the result.

The present disclosure relates to a computer-implemented method

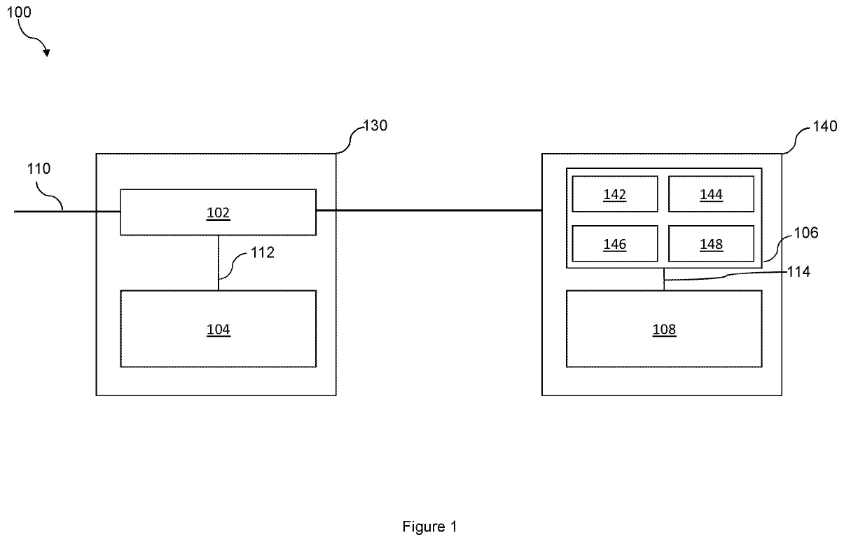

FIG. 1 shows a computing system 100 comprising a classical computer 130. The classical computer 130 comprises a CPU 102 coupled to provide transactions to, and receive transactions from, a conventional memory 104 by means of a memory interface 112. Input information may be received by the CPU from an interface 110. Output information may be provided by the CPU to the interface 110. The classical computer 130 may further comprise additional classical computing elements as known in the art (not shown).

The classical computer 130 is coupled to a quantum computer 140. The quantum computer 140 comprises a quantum computing unit 106 and a quantum memory unit 108, a plurality of coupling devices 142, a bias device 144, and a state determination device 146. The quantum computing unit 106 comprises a number N of qubits 148. The qubits 148 may be for example, superconducting flux devices 148 having a circulating current. For example, the superconducting flux devices 148 may comprise a loop of superconducting material interrupted by at least one Josephson junction, as is known in the art. Further qubit implementations may be envisaged. The quantum computing unit 106 is configured to provide transactions to, and receive transactions from, the quantum memory unit 108 by means of a memory interface 114. A “state” of the quantum computing unit 106 corresponds to the respective state of all of the N qubits. An example state of a qubit is a 0 state. The 0 state may correspond to, for example, a clockwise current around the superconducting flux devices 148 which may induce a downward magnetic field. A counter clockwise current around the superconducting flux devices may induce an upwards magnetic field which references a state 1. The state of the quantum computing unit 106 may be described by a bit string having a length N. Thus, there are 2^{N} possible configurations for the state of the quantum computing unit 106. The quantum computer 140 is a quantum annealer. Other quantum computing models may be envisaged.

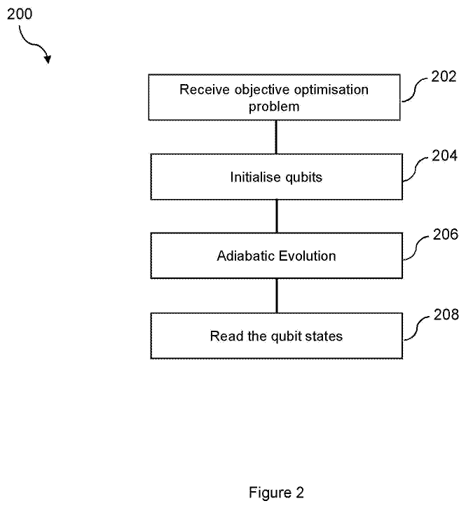

FIG. 2 is an example quantum annealing process 200 carried out by the quantum computer 140 for determining a solution to an objective optimisation problem.

In a first step 202, the quantum computer 140 receives the objective optimisation problem.

Implementing the quantum annealing process first involves initialising 204 the qubits 148 according to an initial Hamiltonian. The initial Hamiltonian corresponds to an initial state wherein the state of each of the N qubits 148 is in a superposition of states 0 and 1 (i.e. each spin configuration is equally likely). This occurs due to the presence of a programmable initialisation bias, for example an external transverse magnetic field generated by the bias device 144. Each qubit 148 minimises its energy in the presence of the programmable bias but is unable to align with the external magnetic field and the qubit state becomes a superposition state of 0 and 1. This state corresponds to the lowest energy state of the initial Hamiltonian.

The process then follows an adiabatic evolution 206, wherein the initial Hamiltonian is evolved to a final Hamiltonian. The final Hamiltonian is representative of the objective optimisation problem. The adiabatic evolution of an evolution Hamiltonian Hₑ may be represented by the equation:

$${H}_{e} = ( 1 - s ) {H}_{i} + s {H}_{f}$$

Wherein the evolution term s may vary from 0 to 1 with time such that the contribution from the initial Hamiltonian tends to 0, thereby resulting in the final Hamiltonian Hf. The evolution term s may be controlled by varying the magnitude of the programmable bias. This magnitude variation is slow enough such that the system stays close to the ground state of the evolution Hamiltonian. When the initialisation bias reaches 0 (i.e. is turned off), the system provides a ground state that corresponds to a ground state of the final Hamiltonian, the ground state preferably being the lowest energy state. This ground state corresponds to a solution of the objective problem.

The state determination device 146 then reads 208 the state of the N qubits, thereby determining a bit string of length N qubits corresponding to the solution of the objective problem.

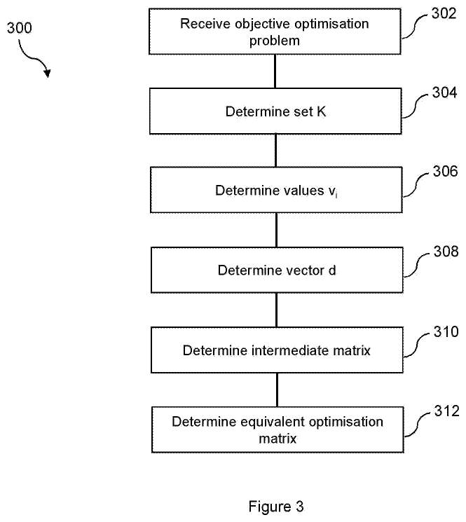

FIG. 3 shows a system a method 300 for optimising the objective optimisation problem using a variable freezing method.

At a first step 302, the objective optimisation problem is received at the classical computer 130. The objective optimisation problem is represented by an L by L QUBO matrix Q. The QUBO matrix Q comprises matrix elements Q_{a,b}, wherein the matrix elements Q_{a,b} are real (i.e. Q_{a,b}∈R). The QUBO matrix Q is also symmetrical such that Q^{T}=Q. The QUBO matrix Q may be represented by m vectors qₐ, wherein the vector qₐ^{T} is the ith row vector of the QUBO matrix Q. The variables representing vectors contain column vectors in all cases. The transposition in the below colunm vector switches the column vectors of the variables to row vectors. However, the data contained in the variable itself still corresponds to a column vector. The QUBO matrix Q may be formulated as:

$$Q = ( \begin{matrix}{q}_{1}^{T} \\ {q}_{2}^{T} \\ … \\ {q}_{L}^{T}\end{matrix} )$$

At step 304, a set K is determined. Set K is a set comprising the vector indices of the QUBO matrix Q. That is, K={1, 2, . . . , L}. Set K comprises a subset J such that J⊆K.

At step 306, a set of values v_{f} are received, the values v_{f} each having constant binary value (i.e. v_{f}∈{0, 1}). The values v are indexed by f, wherein f is a member of subset J (i.e. f∈J). J represents the vector indices of the vectors qₐ of the QUBO matrix Q that correspond to the values v_{f} having a constant binary value.

At step 308, a column vector d is determined by taking a linear combination of the vectors qᵢ corresponding to the values v_{f} by summing, for all values of f in subset J, the vector qₐ scaled by the corresponding value v_{f}, where a is equal to f. This step 308 may be formulated as:

$$d ← {\sum }_{\begin{matrix}a = f , & f ∈ J\end{matrix}} {v}_{f} {q}_{a}$$

The vector d therefore comprises the vectors qₐ corresponding to the values v_{f} having constant binary values. The vectors qₐ corresponding to the values v_{f} of 0 therefore do not contribute to the vector d. The vectors qₐ corresponding to the values v_{f} of 1 do contribute to the vector d.

At step 310, an intermediate matrix Q′ having vectors q′ₐ is determined by adding a diagonal matrix D to the QUBO matrix Q. The diagonal matrix D may be formulated as:

$$D = diag ( d )$$

Accordingly, the dimensions of the diagonal matrix D match the dimensions of the QUBO matrix Q. Step 310 may be formulated as:

$${Q}^{′} ← Q + diag ( d )$$

Finally, at step 312, an equivalent optimisation matrix Q″ is determined having row vectors q″_{b} and column vectors q″ₐ by:

$${Q}^{″} ← {Q}^{′} [ K \backslash J , K \backslash J ]$$

Where Q′[K\J, K\J] is a submatrix obtained by selecting the rows indexed by the first argument (i.e. K\J) and the columns corresponding to the second argument (i.e. also K\J). K\J comprises objects that belong to K but do not belong to J. In the present example, K\J therefore comprises indices that do not correspond to the indices of v_{f}. The equivalent optimisation matrix Q″ is therefore a submatrix of the intermediate matrix Q′. The row vectors q′_{b} of the equivalent optimisation matrix Q″ are obtained by selecting the row vectors q′ₐ of the intermediate matrix Q′ that do not correspond to the values vᵢ. That is, the row vectors q″_{b} correspond to the row vectors q′_{b} where index b∉J. The column vectors q″ₐ of the equivalent optimisation matrix Q″ are similarly obtained by selecting the column vectors of the intermediate matrix Q′ that do not correspond to the values v_{f}. That is, the column vectors q″ₐ correspond to the column vectors q′ₐ where index a∉J.

Accordingly, the equivalent optimisation matrix Q″ has lower dimensions than the QUBO matrix Q. In particular, the equivalent optimisation matrix Q″ comprises dimensions L″×L″, wherein L″=|K|−|J|. Importantly, the equivalent optimisation matrix Q″ retains the information provided by the interaction of the values v_{f}.

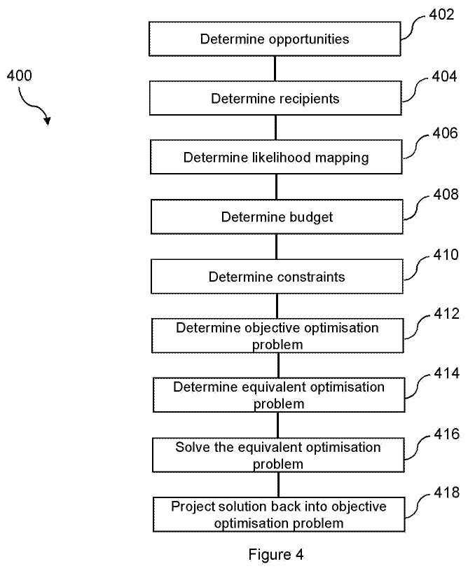

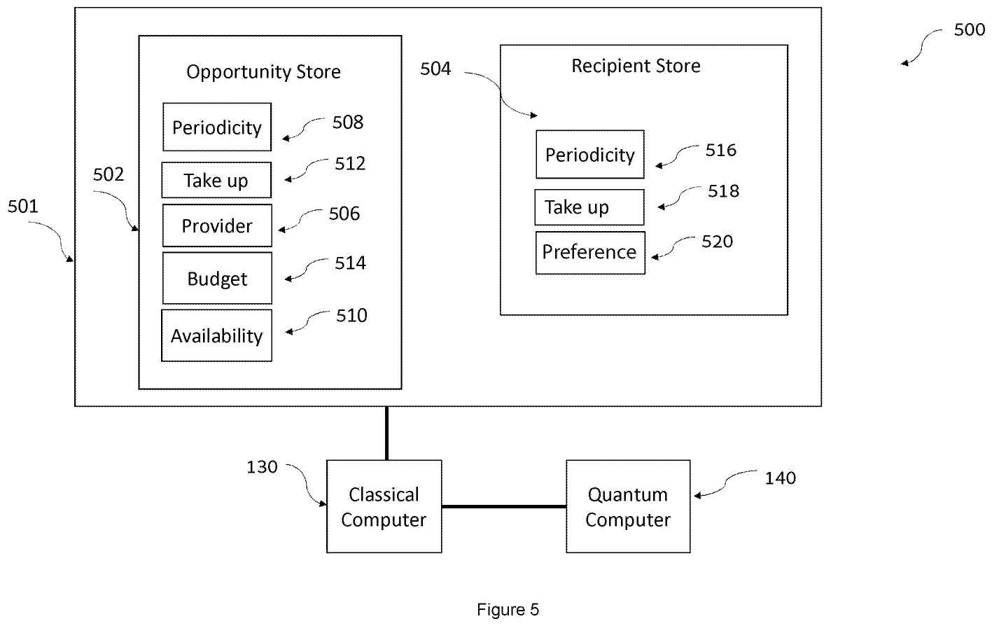

FIG. 4 shows an allocation method 400 according to some embodiments. The allocation method 400 is carried out using the opportunity allocation system 500 shown in FIG. 5, the opportunity allocation system comprising the computer system 100 and an allocation store 501. The allocation store 501 comprises an opportunities store 502 and a recipient store 504. The opportunities store 502 comprises opportunity provider information 506, opportunity periodicity information 508, opportunity availability information 510, opportunity take up information 512 and opportunity budget information 514. The recipient store 504 comprises recipient periodicity information 516, recipient take up information 518 and recipient preference information 520. The allocation store 501 may provide at least one piece of information from the opportunities unit 502 and at least one piece of information from the recipient unit 504 to the classical computer 130.

The opportunity provider information 506 may be information relating to the identities providing opportunities. For example, but not limited to merchants providing discount offers. The opportunity periodicity information 508 may be information related to the time during which an opportunity is available and/or the time between which opportunities are available for a particular opportunity provider. For example, but not limited to the date during which a discount offer from a merchant is available. The opportunity availability information 510 may be information related to the number of opportunities which are available. For example, but not limited to the number of times a discount offer from a merchant may be used or made available to a recipient. The opportunity take up information 512 may be information related to the number of times a type of opportunity has been used in the past by a type of recipient. For example, but not limited to the number of times a discount code from a merchant has been redeemed by a customer. The opportunity budget information 614 may be information relating to the available budget for funding one or more opportunities. For example, but not limited to, the amount of money available to fund a discount code provided by a merchant. The recipient information may be information which an individual has provided in order to receive targeted opportunities. For example, the recipient information may be determined based on factors including, but not limited to, market trends, or historic trends. The recipient periodicity information 516 may be information related to how often a recipient wishes to receive information about opportunities. For example, but not limited to the number of emails containing merchant discount codes a recipient wishes to receive per week. The recipient take up information 518 may be information related to how often a recipient redeems an offer. For example, but not limited to the number of time a recipient has used a discount code from a particular merchant. The recipient preference information 520 may be information related to preferences expressed by a recipient. For example, but not limited to particular merchants from which a recipient would like to receive discount codes. In some embodiments the opportunities store 502 may further comprise additional information related to the characteristics of an opportunity and/or its likelihood of adoption by a recipient. In some embodiments the recipient store 504 may comprise further additional information related to a recipient and their likelihood of adopting an opportunity.

At step 402 of the allocation method 400, a plurality of opportunities are determined based on information from the opportunities store 202. At step 404, a plurality of recipients are determined based on information from the recipient store 204. At step 406, a likelihood mapping is determined wherein the mapping provides an indication of the likelihood that a recipient will accept an opportunity. At step 508, a budget is determined wherein the budget provides an indication of constraints which need to be applied to the system. In some embodiments an additional step 410 involves determining one or more constraints. At step 412, an objective optimisation problem is determined based on the opportunities, recipients, budget, and option additional constraints. At step 414, an equivalent optimisation problem is then determined based on the objective optimisation problem by carrying out the variable freezing method 300. At step 416, the equivalent optimisation problem is resolved on the quantum computer 140 by following the quantum annealing process. Finally, at step 418, an optimised allocation mapping is determined by projecting a solution obtained from step 416 back into the objective optimisation problem.

In some embodiments, steps 402, 404, 406, 408, 410, 412, 414, and 418 are performed by the classical computer 130. Steps 402 and 404 may be performed in parallel or in any order. Steps 406, 408 and optional step 410 may be performed in parallel or in any order.

The likelihood mapping may be determined 406 by generating an Offer-Cardholder matrix R indicative of expected return that a given cardholder will accept a given offer, for all possible cardholders and offers. The resulting offer-cardholder matrix R is shown in Table 1.

TABLE 1
An Offer-Cardholder Matrix

| Offer | Cardholder 1 | Cardholder 2 | . . . | Cardholder n |
|---|---|---|---|---|
| Offer 1 | 0.4 | 0.2 | . . . | 1 |
| Offer 2 | 0.02 | 0 | . . . | 0.1 |
| . . . | . . . | . . . | . . . | . . . |
| Offer m | 0.1 | 0.07 | . . . | 0.35 |

Where each entry rᵢⱼ corresponds to the expected return that a cardholder j will accept or redeem an offer i. The indices i and j are used to address rows and columns in the table respectively throughout this disclosure.

Thus table 1 maps a first set of available offers (offer 1 to offer m) against a second set of available cardholders (cardholder 1 to cardholder n). The entry for each cardholder—offer intersection provides a tendency for the cardholder to accept or use the offer. For example, the tendency for a cardholder n to accept offer 1 is 0.4 whilst the tendency of cardholder 2 to accept the offer 1 is 0.2. This expected return value may be calculated using known techniques. In the present example, the tendency is between 0 and 1, with a tendency of 0 being indicative of the cardholder being guaranteed not to accept the offer, and a tendency of 1 being indicative of the cardholder being guaranteed to accept the offer.

It shall be understood that the offer-cardholder matrix R represents the variables rᵢⱼ in a convenient structure (i.e. a matrix). However, the QUBO formulation does not always support this structure. In order to meet the QUBO form, the offer-cardholder matrix R is flattened such that the variables rᵢⱼ form a vector r having m by n elements. This flattening of the offer-cardholder matrix R may be achieved by converting the offer-cardholder matrix R into a vector with columns stacked on each other. In particular, the vector r may be determined by converting each row of the offer-cardholder matrix R into a corresponding column. These columns are subsequently concatenated. A first column (corresponding to a first row of the offer-cardholder matrix R) forms a first portion of the vector r. A second column (corresponding to a second row of the offer-cardholder matrix R) forms a second portion of the vector r, adjacent the first portion. This is repeated for all rows of the offer-cardholder matrix R, with each row having a corresponding column portion of the vector r. The skilled person will appreciate that additional methods of flattening the offer-cardholder matrix R may be used, for example Fortran-style flattening.

A solution matrix X is also generated. The solution matrix is an in by n matrix corresponding to the offer-cardholder matrix R. Each element xᵢⱼ of the matrix X is a binary variable, i.e. where, after solving, xᵢⱼ∈{0,1}, which reflects the link of offer i to cardholder j. In some embodiments the value 1 may represent the association or allocation of the offer to the cardholder and the value 0 may represent the absence of such an association or that the offer has not been allocated to the cardholder. The solution matrix X also represents the variables xᵢⱼ in a convenient structure (i.e. a matrix). In order to match the QUBO form, the solution matrix R is also flattened such that the variables xᵢⱼ form a vector x having in by n elements.

The objective optimisation problem may be initially formulated as:

$${min}_{{{\{ {x}_{ij} \}}_{}}^{}} ( - {\sum }_{i = 1}^{m} {\sum }_{j = 1}^{n} {x}_{i j} {r}_{ij} ) = {min}_{X} - t r ( X {R}^{T} )$$

Accordingly, the objective optimisation problem is a minimisation of a negative of the dot product between vectors v and r. The skilled person will understand that the negative component is a consequence of the objective of the present offer-cardholder allocation being to maximise (rather than minimise) the allocation of offers to cardholders. Therefore, the initial formulation comprises a vector x*r having L vector elements xrₖ, wherein L is equal to m multiplied by n. Accordingly, the QUBO matrix requires dimensions L by L. The skilled person in the art will understand that the objective optimisation problem may require a plurality of slack variables in order to transform an inequality constraint into an equality. The slack variables may be represented by a slack variable matrix, separate from the QUBO matrix such that the QUBO matrix maintains the dimension L by L.

The complete objective optimisation problem may be determined in step 412 based on the following constraints. The person skilled in the art will understand that these constraints can be effectively re-formulated as a QUBO model by introducing quadratic penalties into the objective function as an alternative to explicitly imposing constraints in the classical sense. These constraints introduce penalties into the objective optimisation problem that lead to it being energetically unfavourable for the constraints to be violated. In particular, the objective optimisation problem is represented by a QUBO matrix, Q, having matrix elements q_{ab}. The skilled person in the art will understand that this QUBO matrix may be formulated as a colunm vector having a series of stacked vectors qₐ^{T} as entries.

A first constraint is a budget acceptance constraint. Each offer has a corresponding financial budget. The budget is determined in step 408 and may be given in terms of the number of instances that the offer can be released or allocated to a cardholder. The budget may also be given as a spending interval instead of a single value. Thus when the budget for an offer i is represented by bᵢ, the budget constraint may be expressed as:

$${b}_{i}^{L} \leq {b}_{i} \leq {b}_{i}^{U}$$

where bᵢ^{L} and bᵢ^{U} are the lower and upper bounds of the allowed spending respectively. In some embodiments where the budget is a soft constraint this mechanism may be used to exceed the budget. This may occur in situations when there is no certainty in regards to the number of redemptions but the offer provider has decided to over allocate opportunities in order to increase the likelihood of adoption.

The budget excess can be calculated using the expected redemption rate. The budget interval may be represented in vector form by means of the vectors:

$${b}^{L} = [ \begin{matrix}{b}_{1}^{L} \\ {b}_{2}^{L} \\ … \\ {b}_{m}^{L}\end{matrix} ]$$

$$And$$

$${b}^{U} = [ \begin{matrix}{b}_{1}^{U} \\ {b}_{2}^{U} \\ … \\ {b}_{m}^{U}\end{matrix} ]$$

The additional constraints are optionally determined in step 410. For example, the number of offers that can be assigned to each cardholder may be bounded by a constant k, leading to the constraint of the limitation for the number of offers allocated to each cardholder being:

$${\sum }_{j = 1}^{m} {x}_{i j} \leq k , ∀ j \to {X}^{T} 1 \leq k 1$$

In some embodiments X^{T}1 may express the sum of xᵢⱼ in a matrix rather than a sum format. In some embodiments 1 may be a vector wherein each of the n values within the vector has a value of 1 and the number n of values is dependent on the size of the matrix expression. The additional limitation which limits the number of offers associated to each cardholder to k, and

$${b}_{i}^{L} \leq {\sum }_{i = 1}^{n} {x}_{i j} \leq {b}_{i}^{U} , ∀ i \to {b}^{L} \leq X 1 \leq {b}^{U}$$

which constrains the available budget each offer (indexed by i) to the minimum and maximum thresholds [bᵢ^{L}, bᵢ^{U}] as described above.

An additional optional constraint may be, for example, groups of mutually exclusive offers. That is, a cardholder cannot be proposed with more than one offer from such group. Thus when, for example, a group of offers:

$$\{ gh \} ⊆ [ 1 , m \}$$

are mutually exclusive, then the additional constraint may be formalised as

$${\sum }_{i ∈ \{ {g}_{h} \}} {x}_{i j} \leq 1 , ∀ j \to {X}^{T} g \leq 1$$

where g is a binary vector representing a membership of a cardholder to the group.

Accordingly, the objective optimisation problem is determined in step 512 as a QUBO problem based on a number of constraints. These constraints introduce penalties into the objective optimisation problem that lead to it being energetically unfavourable for the constraints to be violated.

The equivalent optimisation problem is then determined in step 414, following the method 300, wherein the values v_{f} correspond to entries xrₖ of the vector x*r. The entries xr_{f} in turn correspond to entries rᵢⱼ of the offer-cardholder matrix R that are to be frozen. In particular, values v_{f} corresponding to entries rᵢⱼ that meet a low likelihood threshold are frozen to 0 and values v_{f} corresponding entries rᵢⱼ that meet a high likelihood threshold are frozen to 1. For example, values v_{f} corresponding to entries rᵢⱼ that are less than or equal to 0.05 (i.e. cardholder j is very unlikely to accept offer i) may be frozen to 0, whilst values v_{f} corresponding to entries rᵢⱼ that are greater than or equal to 0.95 (i.e. cardholder j is very likely to accept an offer i) are frozen to 1. The skilled person in the art will understand that each entry rᵢⱼ has a corresponding diagonal component q_{k,k} of the QUBO matrix, wherein k=i*n+J and n is the number of columns in the matrix R.

The equivalent optimisation problem is then resolved in step 416 on the quantum computer 140 by following the quantum annealing process, wherein the final Hamiltonian corresponds to the equivalent optimisation problem. The ground state of the system corresponds to a solution of the equivalent optimisation problem.

Finally, in step 418, the solution of the equivalent optimisation problem is projected back into the objective optimisation problem in order to determine the optimised allocation mapping.

Whilst some embodiments have been described in terms of allocation of card offers to card holders, the described embodiments may be applied to any system designed to allocate opportunities to recipients by modifying the opportunity and recipient information.

Some embodiments may assign housing “opportunities” to “recipient” families on a housing waiting list. In such embodiments, the values in the matrix R may be determined based on a suitability of a home for a particular family. For example, but not limited to a one bedroom home may be more suitable for a single member household than a family of four, whilst a three bedroom home may be more suitable for the family of four than a single member household. The budget constraints may be determined based on a variety of factors comprising, but not limited to rental cost or distance from key infrastructure. Of course, it will be appreciated that the application of embodiments to some problems, such as housing, may provide a recommended starting allocation and rather than a final mandated mapping and the outcome may be manually adjusted before execution.

Some embodiments may assign computer processing tasks to recipient processors, for example, but not limited to CPUs, GPUs, DSPs, GP-GPUs, quantum processor and/or processors optimised for artificial intelligence tasks. In such embodiments, the processors are the recipients and the processing tasks are the opportunities. In such embodiments, in for example, a complex cloud computing infrastructure a large number of tasks, of differing types, requiring execution may be received and a large number of processors may be housed within the cloud computing infrastructure. The values in the matrix R may be determined based on an ability for a particular processor to efficiently execute a particular type of transaction. The budget constraints may be determined based on at least one processor limitation for example, but not limited to, required processing power, required processor speed, required processing accuracy or processor cost. The optional additional constraints may be determined based on factors comprising, but not limited to processor output dependencies, processor maintenance schedules or geographic limitations, such as where data may be stored or processed in accordance with local laws.

In some embodiments the number of recipients may be in the order of millions. In some embodiments the number of opportunities may be in the order of hundreds or thousands. In some embodiments the periodic schedule for sending opportunities may be in the order of one per week. In some embodiments the number of opportunities that may be sent to each recipient may be in the order of tens.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer implemented optimisation method, comprising:
receiving the objective optimisation problem, the objective optimisation problem being represented by an L×L objective matrix comprising a plurality of matrix components;
receiving a set of frozen variables;
determining a set of freezable matrix components corresponding to the set of frozen variables;
determining a contribution vector based on the set of freezable matrix components and the set of frozen variables; and
determining an equivalent optimisation problem based on the contribution vector and the objective optimisation problem, wherein the equivalent optimisation problem excludes the freezable matrix components such that the equivalent optimisation problem can be solved on a quantum computer using fewer quantum bits than the objective optimisation problem would require.

2. The method of claim 1, wherein the objective matrix is a QUBO matrix.

3. The method of claim 1, wherein the matrix components are objective vectors.

4. The method of claim 1, wherein:
the matrix components belong to a vector set;
the set of frozen variables belong to a frozen variable set; and
the frozen variable set is a subset of the vector set.

5. The method of claim 1, wherein the frozen variables are binary variables.

6. The method of claim 1, wherein each of the frozen variables comprise a variable index.

7. The method of claim 6, wherein each of the freezable matrix components each comprise a vector index corresponding to a respective variable index.

8. The method of claim 1, wherein the contribution vector is determined by:
generating a vector comprising the freezable matrix components; and
scaling each freezable matrix component by its corresponding frozen variable.

9. The method of claim 1, wherein the equivalent optimisation problem is determined by:
generating a diagonal matrix based on the contribution vector;
determining an intermediate matrix based on the diagonal matrix and the objective matrix;
removing a plurality of rows from the intermediate matrix, each of the removed rows corresponding to a respective frozen variable; and
removing a plurality of columns from the intermediate matrix, each of the removed columns corresponding to a respective frozen variable.

10. A computer implemented optimisation method, comprising:
determining, by a classical computer, a plurality of opportunities to be allocated;
determining, by the classical computer, a plurality of recipients to be allocated at least one of the plurality of opportunities;
determining, by the classical computer, a respective acceptance likelihood of each of the plurality of recipients accepting each of the plurality of opportunities;
determining, by the classical computer, a respective solvable component of each of the plurality of recipients being allocated each of the plurality of opportunities;
determining, by the classical computer, a first constraint associated with a cost acceptance of each of the plurality of opportunities by the plurality of recipients;
determining, by the classical computer, an objective optimisation problem based on the respective acceptance likelihoods, the respective solvable components, and the first constraint;
determining, by the classical computer, an equivalent optimisation problem based on the objective optimisation problem and the respective acceptance likelihoods;
solving, by a quantum computer, the equivalent optimisation problem, thereby producing an equivalent solution; and
determining, by the classical computer, an optimised allocation of the opportunities to the recipients based on the equivalent solution, the optimised allocation corresponding to the solvable components.

11. The method of claim 10, wherein the first constraint is determined based on a selection from a plurality of constraints.

12. The method of claim 10 further comprising:
determining a second constraint based on a selection from the plurality of constraints; and
using the second constraint in the determining of the optimisation problem.

13. The method of claim 12, wherein the plurality of constraints comprises:
a budget constraint;
a constraint associated with an uptake of each of the plurality of opportunities by the plurality of recipients; and
a constraint that indicates that a plurality of opportunities are mutually exclusive.

14. The method of claim 10, wherein the determination of the acceptance likelihood comprises populating an m by n acceptance likelihood matrix of values, wherein each respective value provides an indication of the likelihood of a recipient j accepting an opportunity i.

15. The method of claim 14, wherein the determination of the respective solvable components comprises populating an m by n solvable component matrix of variables, wherein each element of the solvable component matrix corresponds to a respective element of the acceptance likelihood matrix.

16. The method of claim 15, wherein the objective optimisation problem is determined by:
determining an acceptance likelihood vector;
determining a solvable component vector;
determining a combined vector based on the acceptance likelihood vector and the solvable component vector; and
determining the objective optimisation problem based on:
the combined vector;
the first constraint; and
a second constraint.

17. The method of claim 16, wherein:
the acceptance likelihood vector is determined by flattening the acceptance likelihood matrix; and
the solvable component vector is determined by flattening the solvable component matrix.

18. The method of claim 10, wherein the equivalent solution is provided as an x by y matrix of binary values.

19. The method of claim 18, wherein x multiplied by y is less than m multiplied by n.

20. The method of claim 10, wherein the optimised allocation is provided as an m by n matrix of binary values, each binary value corresponding to a respective solvable component, wherein:
a first binary value provides an indication that a respective opportunity has been allocated to a recipient; and
a second binary value provides an indication that a respective opportunity has not been allocated to a recipient.
